(19) United States
(12) Patent Application Publication
(10) Pub. No.: US 2005/0050209 A1
(43) Pub. Date: Mar. 3, 2005

(54) Method and apparatus to maintain wireless network communications through a firewall

(76) Inventor: James David Main II, Aurora, CO (US)

Correspondence Address: THE MCINTOSH GROUP, 8000 E. PRENTICE AVE., SUITE B-6, ENGLEWOOD, CO, 80111, US

(21) Appl. No.: 10/649,185

(22) Filed: Aug. 27, 2003

(51) Int. Cl. G06F 15/16; G06F 12/14; G06F 11/30; H04L 9/00

(52) U.S. Cl. 709/229; 713/200

(57) ABSTRACT

The present invention relates to a method and apparatus to maintain a data connection over a public, packet-switched, wireless network. An asset tracking system sends heartbeat signals between a mobile device and an asset server. The heartbeats perform several functions. First, the heartbeats inform the asset server that the mobile device is active and on the network and vice versa. Second, a heartbeat from the mobile device provides the dynamic IP address to the asset server for successive communications. Third, a first heartbeat from a mobile device opens a hole in the firewall of the wireless network. Finally, successive communications maintain the hole in the firewall.

### CROSS REFERENCES TO RELATED APPLICATIONS

Not Applicable

### STATEMENT REGARDING FEDERALLY SPONSORED RESEARCH OR DEVELOPMENT

Not Applicable

### REFERENCE TO A “MICROFICHE APPENDIX”

Not Applicable

### BACKGROUND OF THE INVENTION

1. Field of the Invention

The present invention relates to a method and apparatus to maintain open communication pathways between a mobile device and an asset server. More particular, the invention relates to preventing a firewall from closing communication pathways in an asset tracking system.

2. Description of the Related Art

The prior art relates to systems that use wireless networks. In such a system, a person on a cellular phone device communicates with a message recipient. The message recipient could be another person on a landline or cellular phone. Person to person calls are the most common use of cellular systems.

However, wireless systems have started providing other services as cellular technology has advanced. Cellular service providers have started to migrate to newer CDMA and GSM cellular systems. These newer cellular systems allow data transmissions. Data from a sender to a recipient can travel over the cellular network. Thus, text messaging, email, and internet connectivity are all possible. These newer cellular systems operate as packet-switched networks. Packet-switched networks allow a cellular user to send and receive data via internet protocol transmissions. Unfortunately, these advancements in technology have created some problems.

First, the cellular service providers have erected firewalls in the wireless systems. Cellular service providers have erected these firewalls to prevent a deluge of unwanted messages overwhelming the cellular network. A firewall prevents unwanted transmissions from being sent to a cellular user. Typical examples of unwanted messages would include spam email or pop-up windows. To prevent these unwanted transmissions, the firewall blocks any transmissions from systems outside the wireless system. In essence, a cellular user can send data to any system. However, only solicited transmissions reach the cellular devices.

Second, the packet-switched networks also use dynamic IP addressing. Every device in an IP network has an address. This IP address is a set of bits that identify that device in the system. IP addresses function like mail addresses. When a system has information to send to the device, the system uses the IP address. The network routes the information through the system until it reaches the device with the IP address. In newer technology, dynamic IP addressing changes the paradigm. Now, a device does not keep the same IP address all the time. Instead, when a user sends information with the device, the network attaches an IP address to the communication. A responder to the communication can extract that IP address and use it to respond to the information.

Both of these changes have had impacts on systems using wireless networks. In particular, asset tracking systems have been affected by the advances in technology. An asset tracking system is a system that uses mobile devices and attached position finders to monitor the location of the asset. These systems have many applications. In particular, public services, like the police, fire, emergency management systems (EMS), or public works agencies, use these systems to more effectively and efficiently serve the public. Private companies have also adopted asset tracking systems to monitor sales persons, service vehicles, and inventory.

In an asset tracking system, the position finder, usually a GPS device, provides data about the location of the asset to the mobile device. The mobile device sends this information to an asset server. The asset server provides the data to a customer's system. Common customers are GIS systems that graphically display the location of the asset.

The problems the new wireless systems created involve situations when an asset server wants to push data to the mobile device. In many asset tracking systems, the asset servers provide data to the mobile devices. This data may include an address to which a police car or fire engine should respond. Data may also include text messages or driving directions. Unfortunately, asset tracking systems cannot push data in a packet switched network. First, any data sent to the mobile device is blocked by the firewall. A wireless network sees this data as unwanted information and prevents its transmission to the mobile device. Second, the asset server cannot know the mobile devices IP address from one time to the next time. Since the wireless network uses dynamic IP addressing, the asset server could send a message with an IP address once and then, after a period of time, that IP address changes. Thus, subsequent messages fail to get to the mobile device.

Some asset tracking systems have addressed these problems by constructing private networks. In essence, the agency using the asset tracking system builds, buys, or leases all or a part of a wireless network. This type of wireless network is normally called a private network and is dedicated to the asset tracking system. These private networks do not allow transmissions from outside public systems onto the private network. To accomplish this segregation, the private network normally has dedicated transmission lines, IP routers, and other physical hardware. Due to their closed nature, private networks do not need firewalls or dynamic IP addressing. With the threat of unwanted messages eliminated, firewalls are never erected and do not prevent communications in the private network. The private network allows static IP addressing because there are a limited number of devices on the private network. Unfortunately, building, buying, or leasing a private network can be very expensive. Most companies and public agencies do not have the budget to acquire the use of a private network. Thus, these companies and agencies are forced to use the public wireless network and must find another solution to the problems created by the newer packet-switched wireless networks.

Methods and apparatuses are needed to allow asset servers to push data to mobile devices on packet-switched wireless networks.

### BRIEF SUMMARY OF THE INVENTION

The present invention relates to a method and apparatus to maintain a data connection over a private or public, packet-switched, wireless network. An asset tracking system sends heartbeat signals between a mobile device and an asset server. The heartbeats perform several functions. First, the heartbeats inform the asset server that the mobile device is active and on the network and vice versa. Second, a heartbeat from the mobile device provides the dynamic IP address to the asset server for successive communications. Third, a first heartbeat from a mobile device opens a hole in the firewall of the wireless network. Finally, successive communications maintain the hole in the firewall.

### BREIF DESCRIPTION OF THE SEVERAL VIEWS OF THE DRAWINGS

FIG. 1 shows an embodiment of an asset tracking system using heartbeats to open and maintain communication channels in accordance with the present invention.

FIG. 2 shows one embodiment of a mobile device that can use heartbeats to open and maintain communications channels in accordance with the present invention.

FIG. 3 shows one embodiment of an asset server that can use heartbeats to open and maintain communications channels in accordance with the present invention.

FIG. 4 shows a method of using a heartbeat to maintain a communication channel in accordance with the present invention.

FIG. 5 shows an embodiment of a heartbeat in accordance with the present invention.

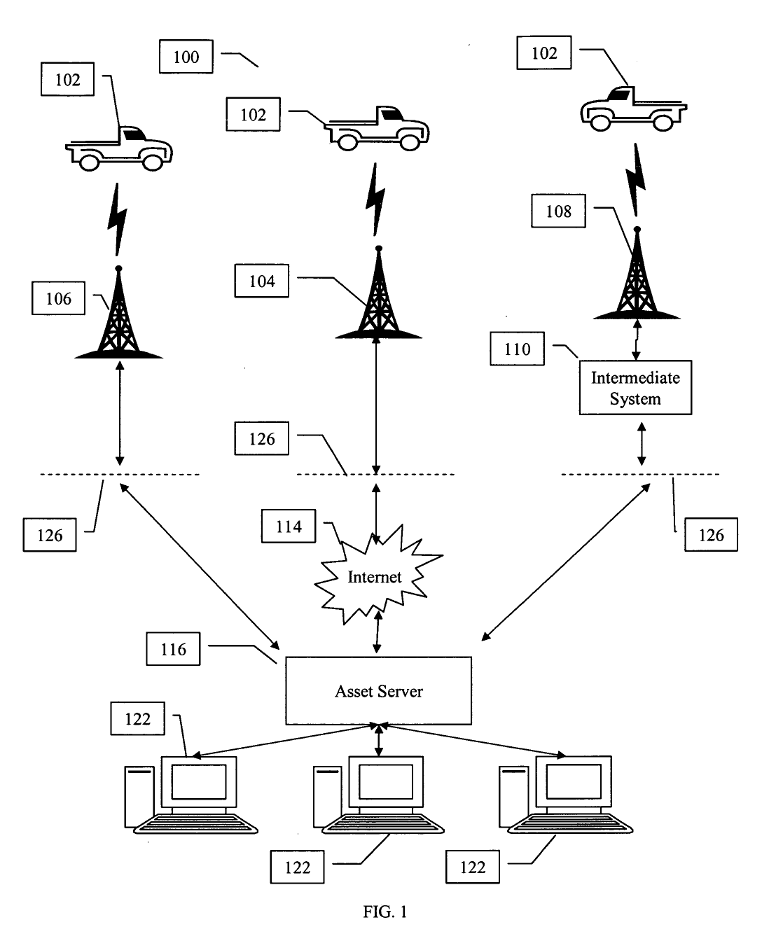

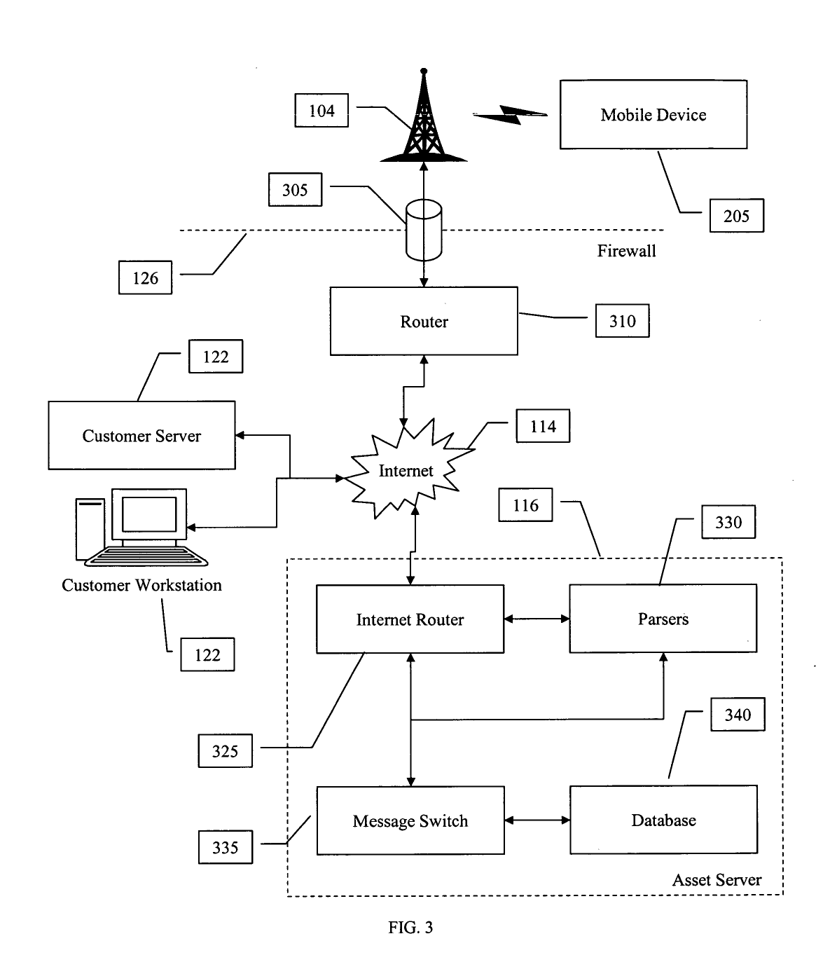

To clarify, each drawing includes reference numerals. These reference numerals follow a common nomenclature. The reference numeral will have three digits. The first digit represents the drawing number where the reference numeral was first used. For example, a reference numeral used first in drawing one will have a number like 1XX while a number first used in drawing five will have a number like 5XX. The second two numbers represent a specific item within a drawing. One item in drawing 1 will be 101 while another item will be 102. Like reference numerals used in later drawing represent the same item. For example, reference numeral 102 in FIG. 3 is the same item as shown in FIG. 1.

### DETAILED DESCRIPTION OF THE INVENTION

The present invention will be described in reference to an asset tracking system 100. However, the invention is not meant to be limited to that one embodiment. For example, the present invention may be used to facilitate the transfer of text messages between a mobile computer and some message recipient. There are other systems that may require continuously open communications in a wireless or other packet-switched network. Therefore, this invention applies to those other systems.

Asset Tracking System

FIG. 1 shows one embodiment of an asset tracking system 100. This embodiment may include, but is not limited to, several assets 102, one or more wireless or packet switched networks 104, one or more internet connections 114, an asset server 116, and one or more customers 122.

The assets 102 in the asset tracking system 100 may include several different things. Some items that may be considered assets 102 include, but are not limited to, people, vehicles, shipping containers, aircraft (airplanes, helicopters, etc.), watercraft (boats, jet skis, etc.), train cars, or goods inventory. Practically anything an organization wants to track can be an asset 102 in an asset tracking system 100. One skilled in the art will recognize other items that may be considered assets 102.

In one embodiment, the assets 102 may be people. For example, the asset tracking system 100 may track the deployment of firefighters to a forest fire. Since vehicles are not able to navigate many wooded areas, people must often respond to forest fires. Thus, the asset tracking system 100 may track these people. Other organizations may track people as assets 102 including the military tracking soldiers, companies tracking salesman, or mining companies tracking miners. One skilled in the art will recognize other situations where an organization may track people as an asset 102.

In the embodiment shown, the assets 102 are vehicles. In this embodiment, the asset tracking system 100 may be an automatic vehicle location (AVL) system. An example of an asset tracking system 100 where the assets 102 are vehicles is the typical system used by city fire or police agencies. In these systems, the assets 102 are the fire trucks or police cars. These vehicles are tracked and directed throughout the city to respond to public safety emergencies. Although FIG. 1 shows the assets 102 as vehicles, the present invention is not limited to that embodiment, but the invention includes all items or things that may be tracked as assets.

To communicate between the asset 102 and the asset server 116, the asset tracking system 100 may employ one or more communication networks, including but limited to, wireless or packet-switched networks 104 (hereinafter referred to as networks, wireless networks 104, or packet-switched networks). The embodiment shown uses antennas to depict the networks 104. While a wireless network 104 is one network 104 that can be used in the asset tracking system 100, the present invention is not limited to that embodiment. Rather, the asset tracking system 100 can employ any type of communication network or packet-switched network. With regards to the wireless network 104, the typical wireless network 104 can be a type of cellular network. A cellular network may include, but is not limited to, a PCS, CDMA, TDMA, FDMA, GSM, or other cellular system. Most common of these systems to use a packet-switched network is the GSM and CDMA systems.

In other embodiments, the wireless network 104 may include a system that utilizes an IEEE 802.11 standard. These 802.11 systems can often be found in buildings and can operate as wireless LANs. Other wireless systems like Bluetooth® or other wireless protocol may also be used by the present invention.

Private networks may also be included in the asset tracking system 100. As explained before, the private network is a non-public system used exclusively by the organization employing the asset tracking system 100. These private networks can include, but are not limited to, conventional or trunked radio systems, dedicated cellular systems or services, leased fiber optic systems, or satellite transmission systems. These private networks may include firewalls also. The present invention may be used to maintain communication pathways in these private networks also. Thus, while this description uses public networks as an example, the invention is not limited to that embodiment. Rather, any network, including private networks, that use a firewall is included in this invention.

In some embodiments, the communications pathway may include an intermediate system 110. An asset 102 may transmit a signal to a wireless or other network which sends the data to an intermediate system 110. That intermediate system 110 can relay the information to the asset server 116. These intermediate systems 110 can include, but are not limited to, other networks, WANs, LANs, or separate computers.

With any of the networks 104, the asset tracking system 100 may encounter one of the problems mentioned earlier. The first problem may be that one or more of the networks employ dynamic IP addressing. Thus, the network 104 may assign the assets 102 using the network 104 an IP address with each sent message. That IP address may change periodically. Dynamic IP addressing is well known in the art and will not be explained further.

Second, the network 104 may employ a firewall 126. This firewall 126 can prevent the asset server 116 from pushing data to the assets 102. Any of the networks 104 mentioned above may employ a firewall 126. In some embodiments, only some of the network 104s may employ the firewall 126 while other networks 104 do not. These firewalls 126 may be a software or hardware device. The firewall 126 may be a part of the network 104 or a separate device coupled to the network 104. Firewalls 126 are well known in the art and will not be explained further.

The asset tracking system 100 may also include an internet connection 114. The internet connection simply means the data is transported over an internet, such as the World Wide Web. As shown in FIG. 1, not all communications may go over the internet 114. Rather, some of the communications pathways may be direct connections from the networks 104 to the asset server 116. For instance, some of the networks 104 may be connected to the asset server 116 by a dedicated T1 line. Other connections are possible. The internet 114 and these direct connections are well known in the art and will not be explained further.

The asset tracking system 100 will likely include an asset server 116. The asset server 116 can function as the central processor in the asset tracking system 100. This server can collect, route, store, and process the outgoing and incoming data. The asset server 116 is explained in more detail below.

A final part of the asset tracking system 100 may include one or more customers 122. The customers 122 may include other systems that further process and use the data from the asset tracking system 100. For instance, these customers 122 may be the actually GIS systems at the user's location that use the asset location data. These systems may include any type of GIS or other system capable of providing a user with information about the assets 102. Customers 122 may also provide information into the asset tracking system 100. One skilled in the art will recognize the different systems or processes that may use the asset data.

Mobile Device

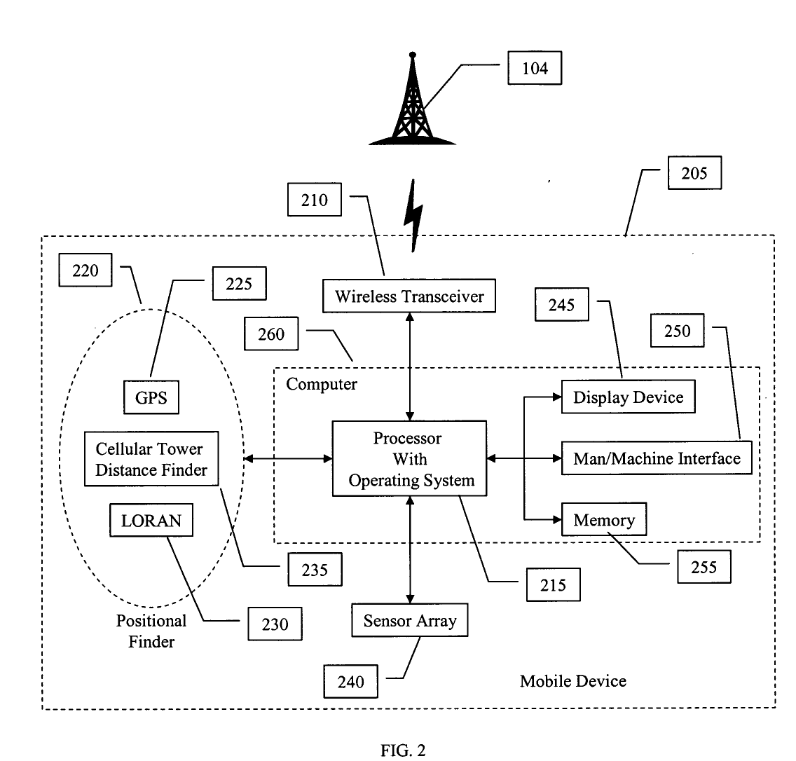

Each asset 102 tracked by the asset tracking system 100 includes a type of mobile device 205. FIG. 2 shows a block diagram of an embodiment of the mobile device 205. A mobile device 205 includes at least a wireless transceiver 210 and a position finder 220. Other components in the mobile device 205 may include, but are not limited to, a processor 215, a sensor array 240, a memory 255, a man/machine interface 250, and a display device 245.

The wireless transceiver 210 includes any device that can send or receive data from a wireless network 104. Devices may include, but are not limited to, radio transmitters, radio handsets used on conventional or trunked radio networks, satellite transceivers, circuit-switched cellular units, or similar devices. A common wireless transceiver 210 may be a cellular modem. The present invention focuses on assets 102 using cellular devices, such as CDPD modems. These cellular devices may include any type of analog or digital cellular device. The cellular device may be capable of text messaging or other cellular functions. Cellular modems and their equivalents are well known in the art and will not be explained further. While cellular devices are used to describe the invention, the invention is not limited to that one embodiment.

The mobile device 205 in an asset tracking system 100 should also include a position finder 220. Without a position finder 220, the asset tracking system 100 would be unable to determine the position of the asset 102. Thus, these devices are inherently needed in a mobile device 205 in an asset tracking system 100. However, if the present invention is not part of an asset tracking system 100, the position finder may not be needed. A position finder may be a LORAN 230 or local positioning system. These systems may use signals from local, land-based systems to determine the position of the asset 102. LORAN systems 230 and their equivalents are well known in the art and will not be explained further. Another position finder 220 may be a system that determines the distance from several cellular towers and can provide a position of the vehicle using the determined distances. This type of system and its equivalents are represented by the cellular tower distance finder 235.

In a preferred embodiment, the positional finder 220 would be a GPS receiver 225. The GPS receiver 225 can receive signals from one or more GPS satellites. A typical GPS receiver 225 decodes and analyzes the pseudo-noise signal from the GPS satellites. The GPS receiver 225 uses the signals to determine a coordinate-based position on the surface of the earth. GPS receivers 225 are well known in the art and will not be explained further. A mobile device 205 can use one or a combination of position finders 220.

Another component in the mobile device 205 may be a processor 215. The processor 215 may be a commercially-purchased microprocessor or microcontroller. As an example, the processor 215 may be from the Intel Pentium™ family, the Motorola PowerPC™ family, or similar type of processor. The processor 215 may also be modeled as a set of logic gates in a specially-designed ASIC or FPGA. For instance, the processor 215 could be modeled in an Altera APEX™ device. Processors 215 are well known in the art and will not be described further

In some embodiments, a set of sensors 240 can be placed on the asset 102. The sensors 240 form the sensor array 240. Hereinafter, the sensors 240 and the sensor array 240 will be explained as interchangeable terms. However, it should be noted that one or more sensors 240 make the sensor array 240. The sensors 240 can measure different systems or characteristics of the asset 102. The sensors 240 may be piezoelectric devices, electromechanical devices, or other devices that can provide telemetry.

In one embodiment, one of the assets 102 may be a vehicle. The sensors 240 can measure parts of the vehicle. For instance, the sensors 240 may measure the pressure in the tires, whether the airbag has been deployed, the amount of fuel in the gas tank, the speed of the vehicle, the current odometer reading, and the achieved miles per gallon. If the vehicle were a snow plow, the sensors 240 may measure whether a plow is up or down. In a fire truck, the sensor array 240 may measure whether a water pump is operating or not, or the water pressure, or the number of hoses being used. Sensors 240 on a police car may measure whether the sirens are one or off, whether a shotgun has been taken from a gun rack, or whether a person is in custody in the backseat.

In another embodiment, the asset 102 is a person. With a person, the sensors 240 may measure different biological functions. For instance, the sensors 240 may measure the heartbeat, the blood pressure, the blood sugar level, the respiration rate, or the body temperature. Any biotelemetry capable of being measured can be monitored by the sensor array 240. Depending on the asset 102, much other telemetry may be gathered by the sensors 240. One skilled in the art will recognize other data that may be obtained from the sensors 240.

The telemetry can include discrete telemetry, analog telemetry, or digital telemetry. Discrete telemetry is usually a binary function. For instance, a police cars lights are either on or off. Discrete telemetry is normally represented by a single bit with a “1” representing the first state and a “0“ representing the second state. Analog telemetry is a digital representation of an analog measurement. For instance, the body temperature of a person may include numerous data points, for instance, 98.7°, 99.2°, or 101.2°. The telemetry would use a plurality of bits to represent what the temperature is at that moment. Finally, digital telemetry is normally a value of some electronic component. For instance, a digital speedometer may be represented by digital telemetry.

In some embodiments, the mobile device 205 may include one or more of a display device 245, a man/machine interface 250, and a memory 255. The display device 245 may be any type of electronic display. Examples may include CRTs, plasma screens, or LCDs. In one embodiment, the display device 245 can provide a GIS map. As part of the GIS information, the display device 245 can show streets, vehicles, locations, or other data. In some embodiments, the display device 245 may display satellite imagery or other photographs of locations of interest. The GIS map may be capable of zoom and pan functions. These GIS maps may be in numerous formats including, but not limited to, ESRI shape files. One skilled in the art will recognize other information that the display device 245 may show. Display devices 245 are well known in the art and will not be described further.

A man/machine interface 250 is any device or system that allows a person to interact with the mobile device 205. An example of one man/machine interface 250 would be a keyboard. The man/machine interface 250 may also be a touch-screen. As in this embodiment, the display device 245 and man/machine interface 250 may be integrated into a single device. Other embodiments may also use a microphone and speaker. A voice recognition system may employ the microphone to allow interaction between the user and the mobile device 205. One skilled in the art will recognize other devices that can function as the man/machine interface 250. Such man/machine interfaces 250 are well known in the art and will not be explained further.

Another component may be a memory 255. The memory 255 may provide a place to store the operating system executed by the processor. However, the processor may have internal memory 255 to store the operating system. In other embodiments, the memory 255 may store information for use by the asset 102. This information may include GIS data. For instance, the memory 255 may store a maps and route information. The memory 255 may include, but is not limited to, any optical, electromagnetic, or electrical memory device. These devices may include, but are not limited to, RAM, ROM, hard drives, optical discs, tapes, or discs. Memory devices 255 are well known in the art and will not be explained further.

In one embodiment, the processor, the display device 245, the man/machine interface 250, and the memory 255 are all included in a computer 260. This computer 260 may be a laptop computer. The computer 260 can perform all the functions of the other devices. In a further embodiment, the computer 260 incorporates all the components of the mobile device 205. Essentially, the computer 260 becomes the mobile device 205. Computers 260 are well known in the art and will not be explained further.

Asset Server

As explained earlier, the asset tracking system 100 will usually also include an asset server 116. Some systems may not include the asset server 116. Rather, the customers 122 receiver the information from the mobile devices 205 directly over the internet 114. The asset server 116 can function as the central device that processes and communicates with the mobile devices 205 and the customers 122. Many embodiments of the asset server 116 exist. One embodiment is shown in FIG. 3. The asset server 116 may include one or more parsers 330 and a message switch 335. Other components may also include, but are not limited to, an internet router 325 and a database 340.

The embodiment shown in FIG. 3 can be used with a wireless network 104. As explained earlier other communication connections may be made to the asset server 116. The asset server 116 includes those embodiments needed to use those other communications connections. More discussion will be given to the alternate embodiments below. In the embodiment shown, the mobile device 205 sends signals to a wireless network 104. The signals are sent onto the internet by a router 310. Those signals may then be received at the asset server 116. Sending signals operates in the reverse order. While FIG.3 shows one specific embodiment, the invention is not limited to that one embodiment.

One device likely part of the asset server 116 is the message switch 335. Essentially, a message switch 335 functions as a data router or a data relay. Incoming data can have an association with a certain system. For instance, data from a fire truck asset 102 has an association with the fire department asset tracking system 100. The message switch 335 assigns an address to the fire truck data according to the association and sends that data to the fire department. The process is similar when data is sent to a mobile asset 102. The fire department sends a location to which a fire truck must respond. The message switch 335 associates the data with one or more fire trucks and sends the message to those assets 102. Similar associations are given to other assets 102 and there tracking systems. Using these associations, the message switch 335 can receive data from a multitude of sources and send it to the appropriate recipients. For instance, fire system messages go to fire department assets 102, police system messages go to police department assets 102, and public works system messages go to public works assets 102. A message switch 335 can include any hardware device or software program that can effectively route the messages. An example of a message switch 335 would be the Nortel Networks Alteon Application Switch. Message switches 335 are known in the art and will not be explained further.

In one embodiment, the message switch 335 provides data to customer systems 122 in an application program interface (API). The API allows customers 122 or external software to use the data obtained from the various mobile devices 205. In other words, the message switch 335 puts the data in a standard format for easy use by other programs. Connections with these outside systems 122 may include any internet 114 or intranet connections. In the embodiment shown, the message switch 335 sends data to the customers 122 via the internet. The message switch 335 sends the message to the internet router 325 that transmits the data to the customer system 122. In other embodiments, the connection between the message switch 335 and the customer system 122 may include, but is not limited to, wireless LANs, WANs, or other systems using TCP/IP protocol.

As described earlier, the message switch 335 may manage multiple assets tracking systems 100. In essence, the message switch 335 can provide the data routing capability for a plurality of asset tracking systems 100. Thus, the message switch 335 may concurrently receive, process, and provide data from a police asset tracking system 100, a fire asset tracking system 100, a snow plow asset tracking system 100, and other asset tracking systems 100. Thus, one message switch 335 supports all possible asset tracking systems 100.

Another component in the asset server 116 is a parser 330. The parser 330 functions as a communications interface between the mobile device 205, the network 104, and the message switch 335. A parser 330 is a communication transceiver. Each parser 330 can connect and communicate to or with a different system or with systems using different protocols. For instance, one parser 330 may communicate with mobile devices 205 using a cellular system. This cellular system may be using a CDPD protocol. Another parser 330 may communicate to mobile devices 205 using GSM cellular systems. Yet another parser 330 may communicate with mobile device 205 using a private radio network 104. Another parser 330 may communicate through a satellite link using an MPEG protocol. The parsers 330 may use any type of communications system or protocol. There is one parser 330 for each type of system or each type of protocol.

The parsers 330 can receive all the incoming data in different formats. The parser 330 can translate this data from the specific protocols into a standard format. Thus, the parser 330 is a translation device. The parser 330 can be a hardware device or software for changing data in one format into another. While the embodiment shown only has one parser 330, there may be a plurality of parsers 330. One parser 330 can be created for each communication network 104. In this way, the asset server 116 may only need one message switch 335 for all the different types of network 104s that may be used. Thus, adding new mobile devices 205 using new network 104s only requires the addition of more parsers 330. Such a system provides maximum flexibility because a user does not need to create a new message switch 335 every time a new system is added.

Data sent to the message switch 335 is in a standard format. In the embodiment shown, the standard format would be TCP/IP. However, one skilled in the art will recognize other protocols that may be used for the standard format. Also the standard format may also describe the arrangement of the data. For instance, the asset identifier may precede the asset telemetry and asset position. One skilled in the art will recognize the different arrangements of the data that are possible. A parser 330 may also rearrange the formats and protocols of out-going messages. Thus, the parser 330 can take data in the standard format and translate it into the protocol and format specific to the mobile device 205.

The asset server 116 may also include a database 340. A data base is a storage system for asset tracking data. The database 340 may be any type of storage device including, but not limited to, electromagnetic, magnetic, optical, or electrical. An example would be the StorageTek PowderHorn® 9310 System. Other examples may include RAID systems or a storage disc system like one from the lomega Zip disc family.

Another component may be an internet router 325. An internet router 325 may be any transceiver that can send and receive messages over the internet. The internet router 325 can help the message switch 335 send information to third party systems. The internet router 325 may also receive data from a mobile device 205 and send it to the parser 330. Internet routers 325 are well known in the art and will not be explained further.

In some embodiments, the asset server 116 may be a single computer or several connected computers. For instance, the asset server 116 may include several servers connected as a network 104. This type of distributed computing may also use other components such as mainframes or workstations. In one embodiment, all the connected devices transfer data using TCP/IP protocol. Data goes through the message switch 335. At the message switch 335 the data can be sent to another asset server 116. In another embodiment, two asset servers 116 concurrently receive the data. One of the asset servers 116 can function as a back-up.

Using IP addresses, the asset tracking system 100 may have several separate systems running in parallel. For instance, the asset server 116 may have a back-up system. The back-up system need not be collocated with the primary asset server 116. Rather, the back-up system can be located in another building, another city, another state, or another country. Any data going to the primary asset server 116 may be copied and retransmitted to the back-up station. The back-up station may have the same IP address and receive duplicate messages from the transmitting devices. A back-up station may have duplicate systems or a different configuration from the primary asset server 116. One skilled in the art will recognize that there are other architectures and other connections are possible for the asset tracking system 100.

In other embodiments, a customer system 122 may be connected to the asset server 116. The customer systems 122 may include, but are not limited to, workstations, mainframes, or server-based system. In the embodiment shown, the customer system 122 is connected to the asset server 116 by the internet. However, any communication connection may be employed including, but not limited to, LANs, WANS, or wireless LANs. The protocol for this connection may be TCP/IP. One skilled in the art will recognize other protocols that may be used. Also, as explained earlier the data sent to the customer system 122 may be in an API format. This format ensures data is sent and received in the same arrangement every transmission. Thus, any configuration mismatches between the customer system 122 and the mobile devices 205 are eliminated.

Method for Maintaining Open Cellular Communications

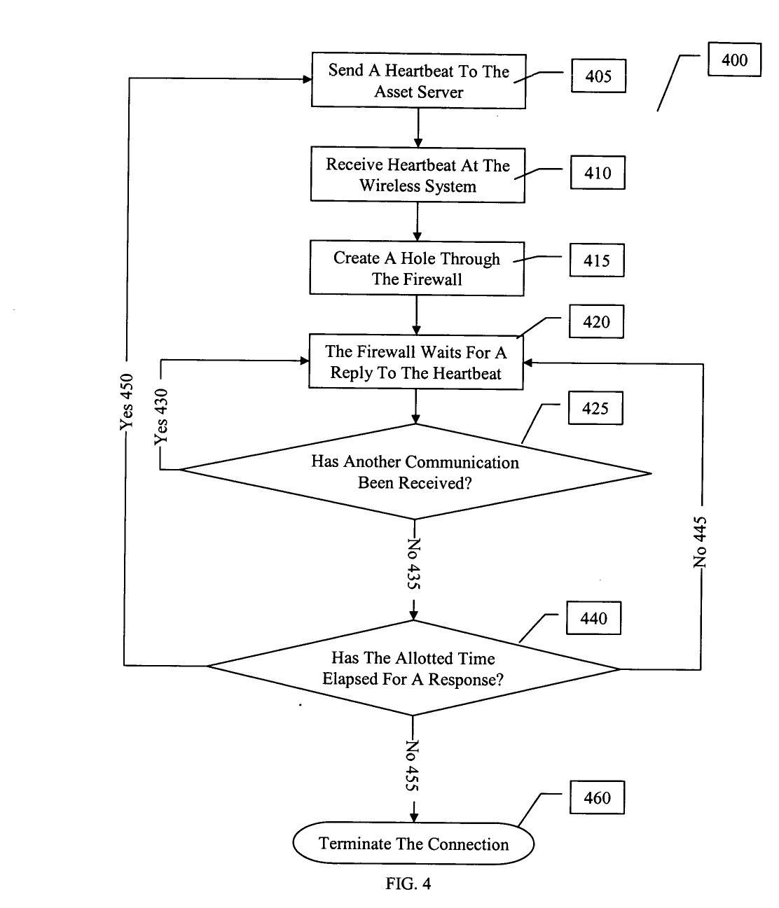

Now turning to FIG. 4, it shows one embodiment of a method 400 for maintaining a communication pathway or connection through a wireless network firewall 126.

In an embodiment, the mobile device 205 sends a first heartbeat 405 to the asset server 116. The processor 215 creates the heartbeat. In other embodiments, the wireless transceiver 210 creates the heartbeat. Regardless, the heartbeat may take many forms and be created by various systems.

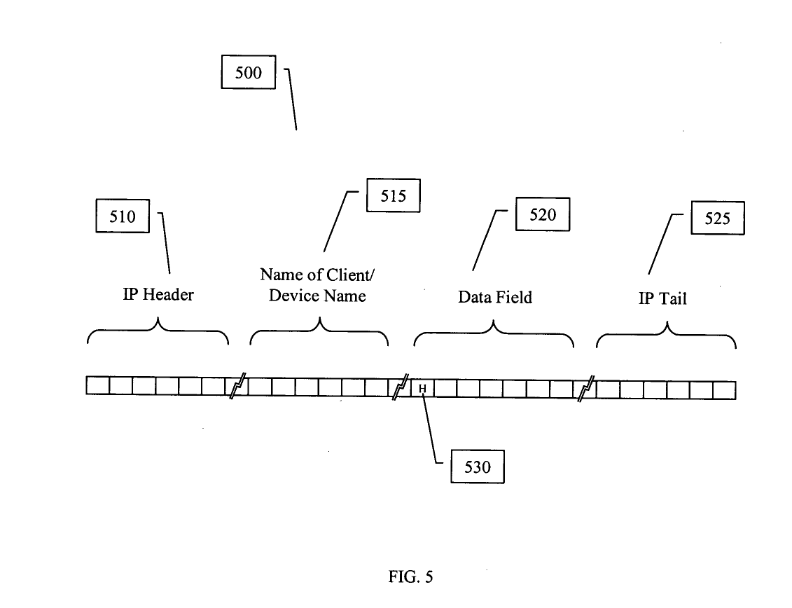

One embodiment of the heartbeat 500 is shown in FIG. 5. The heartbeat 500 may be analog, but the preferred embodiment uses a digital signal. The digital heartbeat 500 may have any arrangement or number of bits. In FIG. 5, the heartbeat 500 has several fields. Those fields may include, but are not limited to, the name of the client 515 (what asset tracking system 100 the mobile device 205 belongs to), the name of the mobile device 515, the data field 520, and the IP protocol header 510 and tail 525. In most embodiments, the IP header 510 and tail 525 are added to the heartbeat 500 by the wireless network 104. All of the fields may have varying lengths. Some fields may be a bit in length while others are thousands of bits or bytes. The lengths of many of the fields can be determined by the protocol used in the asset tracking system 100. Also, the fields may have varying lengths from one signal to the next.

The IP header 510 can include the dynamic IP address of the mobile device 205. The name of the device 515 may provide the asset tracking system 100 the data to identify the mobile device 205 in the system. In the embodiment shown, the data field 520 only has a single item in the field. The “H” 530 represents an ASCII “H.” The “H” 530 is the actual heartbeat 500 indicator. While other types of data may be used for the heartbeat 500, the ASCII “H” provides a simple piece of data to recognize the signal. The IP tail can provide other data for use in the wireless network 104. One skilled in the art will recognize other possible embodiments of the heartbeat 500.

A wireless network 104 receives the heartbeat 500. In an exemplary embodiment, a cellular tower receives 410 the cellular transmission from the wireless transceiver 210. The cellular tower relays the signal to the cellular system's phone exchange or central office. At this point, the heartbeat 500 can be placed on the internet 114.

The heartbeat 500 reaches a firewall 126. The firewall 126 can recognize that the heartbeat 500 is an out-going signal. Thus, the firewall 126 opens 415 a hole 305 in the firewall 126. The firewall 126 assigns a port for the heartbeat 500 to be sent out. The firewall 126 can assign a time-out clock to this port. In other words, the firewall 126 will leave the port open for any further communication for a set period of time. The set period of time may vary greatly. In some wireless networks 104, the set period of time may be fractions of a second, while in other networks 104 the set period of time may be 30 seconds or longer. Thus, the firewall 126 waits 420 for a reply or further communication for the set period of time.

While the firewall 126 waits for a reply, it may check 425 to determine if a response has been made. In another embodiment, the cellular system may receive a notice if a reply is received. If no response has been received 435, the firewall 126 checks to determine if the time-out has expired 440. In essence, the firewall 126 determines if the set period of time has elapsed. If the elapsed period of time has not elapsed, the firewall 126 can continue to wait 445.

Meanwhile, the heartbeat 500 can travel the internet to the internet router 325. The parser 330 can receive the heartbeat 500 from the internet router 325 and format the heartbeat 500 into the standard format. At this point, the parser 330 can relay the heartbeat 500 to the message switch 335. In this way, the mobile device 205 and the message switch 335 have formed a communication pathway. Anytime before the set period of time expires, the message switch 335 may push data to the mobile device 205 without the firewall 126 blocking the transmission.

The message switch 335 can record the dynamic IP address from the IP Header 510 of the heartbeat 500 and be able to assign that IP address to any reply messages. The dynamic IP address will remain accurate until the set period of time expires. In that situation, the mobile device 205 may need to send another heartbeat 500 to reestablish a connection, and this new heartbeat 500 will include a new IP address. The new heartbeat 500 may be sent on a regular period. For instance, if the time-out occurs every 30 seconds, the mobile device 205 may send the heartbeat 500 on a period of every 20 seconds. In other embodiments, the heartbeat 500 may be sporadic. Essentially, the heartbeat 500 is not sent on an established period, but the heartbeat 500 is sent out at random intervals that do not exceed the time-out of the hole 305 in the firewall 126. A sporadic heartbeat 500 may have a pattern that has a second heartbeat 500 follow the first heartbeat 500 by 22 seconds, a third heartbeat 500 follow the second heartbeat 500 by 12.6 seconds, and so on. In other embodiments, the heartbeat 500 may be triggered by an event. For instance, every time the communications pathway usage falls below 50%, the heartbeat 500 may be sent. The heartbeat 500 may also be sent if no message has been sent for a set number of seconds that is less than the time-out. For example, if a communication has not been sent for 15 seconds, then a heartbeat 500 would be sent. One skilled in the art will recognize other events that could trigger the heartbeat 500. One skilled in the art will also recognize other sequences, intervals, or methods for sending out the successive heartbeats 500.

Beyond these effects of receiving the heartbeat 500, the heartbeat 500 functions as a state of the system message. An asset tracking system 100 often requires a process to determine whether the system is functioning properly. One process that is known in the art is polling. Polling requires a central device to send a poll to each connected device and receive a reply from that device. As the number of devices on the system increases, the number of polls increases. When the number of connected devices becomes prolific, polling becomes difficult to manage. A list is usually created and the central device scrolls through the list polling the devices one at a time and awaiting the reply. Unfortunately, this process requires a great deal of processor usage and is overly cumbersome. Thus, heartbeats 500 can provide a simple and less cumbersome method to check functionality.

Heartbeats 500 eliminate the need to poll connected devices. In this embodiment, each connected mobile device 205 sends a signal to the message switch 335. The signals are periodic. For instance, a mobile device 205 may send the signal every 30 seconds. Regardless, the signal identifies the mobile device 205 sending the heartbeat 500 to ensure the asset server 116 can determine what mobile devices 205 are on the system and which are functioning. The name of the device 515 or name of the client 515 may function as the identifier in a heartbeat 500.

Now that a communication pathway has been formed between the mobile device 205 and the asset server 116, there may be several methods to maintain this pathway. First, either the mobile device 205 or the asset server 116 can send other communications. The firewall 126 can understand these other communications as a reply 425 from the asset server 116 or a continuation of the transmission from the mobile device 205. The types and content of these other communications will be explained further below.

The mobile device 205 may send information including, but not limited to, text messages or asset tracking information. This asset tracking information may include, but is not limited to, the asset's position, asset telemetry, or other information. This information can update the asset server 116 or the customer systems 122. Each asset 102 can periodically send this information. Thus, the asset tracking system 100 can stay current on position or status of the asset 102.

The asset position can be one of the items of information sent by the mobile device 205. In one embodiment, the GPS 225 determines the coordinate position of the asset 102 at a moment in time. Those coordinates are sent to the processor 215. The processor 215 can save in memory 255 and display on the display device 245 the position. In this way, the asset 102 knows the position. The processor 215 also creates the message that the wireless transceiver 210 will send. After composing the message, the processor 215 forwards the message to the wireless transceiver 210 for transmission.

The transmission enters the wireless network 104 where it reaches the firewall 126. Since a hole 305 has already been created in the firewall 126, the firewall 126 sends the message through the same port assigned to the past heartbeat 500. However, even if the hole 305 were closed in the firewall 126, the firewall 126 may still allow the transmission since it is an out-going message.

The message travels through the internet 114 where it is received at the internet router 325. The parser 330 translates the message and relays it to the message switch 335. At this point, the message switch 335 determines the client the message belongs to and forwards the message to one or more of the customers 122. The asset telemetry is sent to the asset server 116 in like fashion. However, the sensor array 240 provides the information. In this embodiment, the sensor array 240 measures a part of the asset 102, for example, the tire pressure. That information is put into a message and sent to the asset server 116.

In addition, the asset server 116 may send information to the mobile devices 205. Information sent to the mobile device 205 takes the reverse path of the information received. In an exemplary embodiment, the customer 122 or message switch 335 originates the message. At the message switch 335, the information is placed in a format for the parser 330. The parser 330 receives the information and further formats the information for transmission on the specific communications medium. The parser 330 then transmits the message. In one embodiment, the message is sent to the internet router 325 that transmits the information over the internet 114. The information eventually reaches the router 310. At this time, the wireless network 104 must determine if this information is an unwanted message. Thus, the firewall 126 reviews the message to determine 430 if it is a reply to a sent message. If the message was received within the first set period of time, then the message will be considered a reply. The message will pass through the hole 305 in the firewall 126. At the cellular tower, the information is transmitted to the mobile device 205 where the processor 215 can store it or display it. In a situation such as this embodiment, the firewall 126 may renew the set period of time. In essence, the firewall 126 resets the time-out and grants a second set period of time for added communications. The second period of time may be longer or shorter than the first set period of time. In this way, the successive communications can keep the hole 305 open in the firewall 126 without additional heartbeats 500.

There are many types of information that may be sent to the mobile device 205. Some of this information may include, but is not limited to, a position to which the asset 102 should proceed, real-time information, information about other mobile devices 205, a map, a set of directions, a text message, or a heartbeat 500. Some of this information may also be stored at the mobile device 205. For instance, the computer 205 can store maps, GIS information, routing information, and other items. In the embodiments that follow, the information will be explained as being sent to the mobile device 205. One skilled in the art will recognize what information may be stored at the mobile device 205.

The first type of information that may be sent to the mobile device 205 is information about other assets 102 in the asset tracking system 100. In this embodiment, one asset 102 may transmit status, position, or other information to the message switch 335. The message switch 335 can then echo or relay this information to the other mobile devices 205. Again, the name of the client or name of the device allows the message switch 335 to know what mobile devices 205 should receive that information. In this way, every mobile device 205 in the asset tracking system 100 can display and store GIS and other information about all other mobile devices 205. This type of system allows command and control of an assent tracking system 100 from the field. Managers and directors can actually see and direct assets 102 from the field. An example of this application may be a forest fire fighters unit. The fire team leader can use their own mobile device 205 to see their crew. That team leader can direct or instruct those personnel according to the information they see on their display device 245. Other information to send and other applications will be recognized by one skilled in the art.

Another source of information may be real-time information. The real-time data should have some temporal relationship to the moment the data is sent. Real-time information can be any data or information obtained at that moment or within the recent past. Data that is a day old may still be real-time if no update of that information is available. Also, the data may be real-time if it is retrieved recently, but its creation was in the past. The real-time information may be about a status of a location. For instance, a police department may send a police car to an address. This position is a location of a house. The real-time information may pertain to past police visits to that house. Some examples of this real-time information may include, but are not limited to, blueprints of a building, number of occupants of a building, items stored at a building, descriptions of the occupants, a history of the location, or a history of the occupants. A description of the occupants may include, as an example, be a height, a weight, a color of eyes, a color of their hair, or other characteristics. The history of the occupant may include, but is not limited to, past arrests, past criminal convictions, medical information, employment history, or other information. Items stored at a building may include what inventory is in a warehouse or other data. An example of this type of information would be an inventory of flammable chemicals in a warehouse given to firefighters for their edification. A history of a location may include past police visits, any condemnations of the property, past fires at the location, or other information.

The real-time information may also include information about how to get to the location. This information may include, but is not limited to, a traffic condition, a light signal status, a traffic accident report, a best route to the location, or a parking condition. Some of the information can describe current traffic conditions. For instance, the information may describe where traffic jams are occurring and how to circumvent those areas of heavy traffic. This information may come from sensors placed along, under, or above the roads. A simple pressure sensitive monitor can count the passage of cars and forward this information to the message switch 335. Similar monitors can forward the status of the traffic lights to the message switch 335. A police car may report a traffic accident and provide information about what roads to avoid in the future. All of this information may be interpreted into a best route. The best route would describe a set of directions to the location. These directions can allow the asset 102 to navigate the roads without encountering heavy traffic, traffic accidents, or red lights. Also, the information may include parking conditions. For instance, a service vehicle may need a place to park in the downtown area of a city. The real-time information can include information from parking meters or parking lots showing vacancies. Thus, the asset 102 can find a parking space quickly without searching.

Another source of real-time information may include location imagery. Imagery may be any form of visual data in any spectral wavelength. Examples of this imagery may include, but are not limited to, satellite imagery, aircraft imagery, remote camera imagery, or imagery from a mobile device 205. Satellite and aircraft imagery are visual information obtained from sensors on satellites or aircraft. A remote camera may be a permanently placed imager or other device that can transmit the information back to the message switch 335. The remote camera may also be a part of a mobile system like a train car, a watercraft, or other form of transportation. In addition, the imagery may come from an asset 102 in the asset tracking system 100. Thus, the imagery can function as a feedback from an asset 102 sent to scout, assay, or reconnoiter a situation. For example, a fire fighter might be sent to take digital pictures of a forest fire and transmit the digital images to the asset tracking system 100.

This imagery may be from a dedicated satellite that is part of the asset tracking system 100. Also, the imagery may come from some service or agency. For instance, the asset tracking system 100 may download information from a government system via an internet delivery service such as available from the NOAA DMSP, POES, or GOES systems. These satellites may provide one or more images in the different spectral bands. Also, the imagery may come from a private company, such as images from Space Imaging, Inc. The images may even come from an educational institution like the Space Science and Engineering Center at the University of Wisconsin at Madison. One skilled in the art will recognize other available sources of information that may provide imagery. Also, one skilled in the art will recognize the different delivery methods for the imagery. These delivery methods may include, but are not limited to, internet download, email delivery, dedicated link transfer, or mail.

The imagery may be from any spectrum. Thus, the imagery may include, but is not limited to, information from the infrared, visual, sonic, ultraviolet, microwave spectrum. For example, imagery of a forest fire may include visual pictures of the fire, infrared information about fire hotspots, and microwave imagery about moisture conditions. One skilled in the art will recognize other spectrums and products that may be included as imagery.

To enter the imagery into the system, a separate processor or a customer 122 may input the imagery into the system. This imagery may include a set of positioning information, such as GPS 225 coordinates for points on the image. In other embodiments, landmarks in the image may need to be pinpointed and the location information for those landmarks input. Locating landmarks may be done by using a visual display that allows a user to electronically mark a landmark, like a lake, mountain, building, or structure. The user can then use a database 340 to input GPS 225 coordinates for the landmark. With the positioning information, the asset tracking system 100 may place this image in the asset tracking system 100 as a background display. One skilled in the art will recognize other methods of entering the image information into the asset tracking system 100. One skilled in the art will recognize other types of real-time information that may be sent to the mobile device 205.

In another embodiment of the invention, the message switch 335 or the mobile device 205 may send text messages as a form of information. Text messages are communications using text to convey a message to the recipient. For instance, a text message may communicate information to the asset 102 that cannot be displayed or conveyed in another form. These text messages may originate with or be addressed to the mobile device 102, the customer 122, the asset server 116, or some other system. An example of a text message may be the dispatch center telling the police officer, using the asset 102, that his or her child is in the hospital and he or she should leave work immediately. There are numerous other examples of text messages, and one skilled in the art will recognize those different possible text messages. Text messages have been used in internet communications. Text messages are well known in the art and will not be explained further. However, it should be noted that the present invention may facilitate text messaging in other networks not just in asset tracking systems 100. For instance, the present invention may maintain communication pathways for a mobile computer (the mobile device 205) to use text messaging over a wireless network (the communication network 104). One skilled in the art will recognize the different networks and applications for the present invention to facilitate text messaging.

A situation may occur where no information is sent 435 between the mobile device 205 and the message switch 335 for a long period of time. The wireless network 104 can also determine 440 if this absence of communication runs longer than the set period of time that the hole 305 remains open. If the time-out for the hole 305 has not elapsed 445, the wireless network 104 may continue to wait for a communication 420. If the time is about to elapse 450, another heartbeat 500 may be sent 405 between the mobile device 205 and the asset server 116. Heartbeats 500 from the asset server 116 to the mobile device 205 may also be sent 405. These heartbeats 500 can allow the mobile device 205 to determine if the mobile device 205 is still connected to the asset tracking system 100. If the scheduled heartbeat 500 is not received and the time has elapsed 445, the mobile device 205 can reconnect by reestablishing (not shown) a wireless connection. These heartbeats 500 also can inform the mobile device 205 if the asset tracking system 100 is functioning. For instance, if the asset server 116 is down, the mobile device 205 will not receive heartbeats 500. The mobile device 205 may then inform the user of the mobile device 205 that alternate communications may be necessary.

Either the asset server 116 or the mobile device 205 may send a successive heartbeat 500. Thus, either device may know when the set period of time expires for keeping the hole 305 open. Before that time expires, either device may send a new heartbeat 500. This new heartbeat 500 can reset the set period of time or can establish a new set period of time. The successive heartbeats 500 can maintain the hole 305 through the firewall 126 without any communications between the mobile device 205 and the asset server 116. In this way, the heartbeats 500 maintain the communications pathway indefinitely. The connection can allow the asset server 116 to push data whenever required without the mobile device 205 establishing a new connection.

In some embodiments, a new heartbeat 500 may not be sent. The asset tracking system 100 may desire to terminate the connection 460 between a mobile device 205 and the asset server 116. For instance, if a service vehicle will not be used overnight, the heartbeats 500 may stop and the connection terminated. One skilled in the art will recognize other situations where the connection may be terminated. The wireless network 104 can simply close the hole 305 in the firewall 126. If no heartbeats 500 or other communications are transmitted between the mobile device 205 and the asset server 116, the set period of time lapses and the wireless network 104 can close the hole 305. Thus, unused assets 102 may not remain on the system 100 and require data pushed to that mobile device 205. In other embodiments, either the mobile device 205 or the asset server 116 may instruct the connection to be terminated. One skilled in the art will recognize other methods for terminating the connection.

1. A method to maintain a communications connection through a firewall in a network used for pushing information to and receiving information from a mobile device, comprising:
a. sending a first heartbeat signal between the mobile device and an asset server;
b. receiving the first heartbeat signal at the firewall;
c. opening a hole in the firewall to allow communication between the mobile device and the asset server;
d. holding the hole open for a first set period of time; and,
e. sending a successive communication before the set period of time expires, wherein the successive communication causes the firewall to leave the hole open for a second set period of time.

2. A method according to claim 1, wherein the network is a wireless network.

3. A method according to claim 1, wherein the network is a packet-switched network.

4. A method according to claim 1, wherein the successive communication is information the mobile device sends to the asset server through the hole.

5. A method according to claim 4, wherein the mobile device is part of an asset in an asset tracking system.

6. A method according to claim 5, wherein the sent information pertains to an asset position.

7. A method according to claim 6, wherein the asset position is information about one of GPS coordinates, directions, speed, LORAN position, street address.

8. A method according to claim 7, wherein the GPS coordinates are provided by a GPS receiver communicatively coupled to the mobile device.

9. A method according to claim 5, wherein the sent information pertains to an asset status.

10. A method according to claim 9, wherein the asset is a vehicle.

11. A method according to claim 10, wherein the asset status is information about one of speed, direction, airbag deployed, engine on, tire pressure, fuel level.

12. A method according to claim 9, wherein the asset is a person.

13. A method according to claim 12, wherein the asset status is information about one of a body temperature, a heartbeat, a blood pressure, a blood sugar level, or a respiration rate.

14. A method according to claim 1, wherein the successive communication is information the mobile device receives from the asset server through the hole.

15. A method according to claim 14, wherein the asset server includes at least one parser and a message switch.

16. A method according to claim 14, wherein the mobile device is part of an asset in an asset tracking system.

17. A method according to claim 16, wherein the received information pertains to at least one other asset in the asset tracking system.

18. A method according to claim 16, wherein the received information pertains to a position to which the asset should proceed.

19. A method according to claim 18, wherein the received information includes real-time information.

20. A method according to claim 19, wherein the real-time information is about a status of a location at the position.

21. A method according to claim 20, wherein the real-time information includes one of blueprints, occupancy, items stored at the location, a history of the location, or a history of occupants at the location.

22. A method according to claim 21, wherein the real-time information is about one of a traffic condition, a light signal, a traffic accident, a best route, or a parking condition.

23. A method according to claim 19, wherein the real-time information is imagery of the position.

24. A method according to claim 23, wherein the imagery includes satellite imagery.

25. A method according to claim 1, wherein the successive communication is a successive heartbeat.

26. A method according to claim 1, wherein the heartbeat signal is specific to the mobile device that originates the heartbeat.

27. A method according to claim 26, wherein the heartbeat is a digital signal, wherein the digital signal includes at least one bit that identifies the mobile device.

28. A method according to claim 1, wherein the asset server includes at least one parser and a message switch.

29. A method according to claim 28, wherein the message switch receives and processes signals from a plurality of mobile devices.

30. A method according to claim 29, wherein the message switch routes signals to at least one connected device or system.

31. A method according to claim 30, wherein the connected system includes one of a customer system, a database, or mobile device.

32. A method according to claim 1, wherein the mobile device is a cellular device.

33. A method according to claim 32, wherein the cellular device sends and receives digital signals.

34. A method according to claim 33, wherein the cellular device includes a digital modem to send data to and receive data from the cellular network.

35. A method according to claim 34, wherein the cellular device multiplexes a plurality of data streams into an out-going data stream.

36. A method according to claim 35, wherein the plurality of data streams includes one of voice data, asset position data, asset status data, the heartbeat, or mobile device identifier.

37. A method according to claim 1, wherein a first heartbeat includes a dynamic IP address for the mobile device.

38. A method according to claim 1, wherein the asset server record the dynamic IP address to communicate with the mobile device in the future.

39. A communication system to maintain a hole in a firewall, comprising
a. a mobile device;
b. a wireless network connected in communication with the mobile device, wherein the wireless network includes a firewall;
c. an asset server connected in communication to the cellular network; and,
d. wherein a first heartbeat sent between the mobile device and the asset server opens the hole in the firewall and at least one successive communication maintains the hole.

40. A communication system according to claim 39, wherein the mobile device is a cellular device.

41. A communication system according to claim 39, wherein the wireless network is a cellular network.

42. A communication system according to claim 39, wherein the wireless network is a packet-switched network.

43. A communication system according to claim 39, wherein the communications system is part of an asset tracking system.

44. A communication system according to claim 43, wherein the mobile device is part of an asset in the asset tracking system.

45. A communication system according to claim 44, wherein the mobile device sends information to the asset server through the hole.

46. A communication system according to claim 45, wherein the sent information pertains to an asset position.

47. A communication system according to claim 46, wherein the asset position is information about one of GPS coordinates, directions, speed, LORAN position, or street address.

48. A communication system according to claim 47, wherein the GPS coordinates are provided by a GPS receiver communicatively coupled to the mobile device.

49. A communication system according to claim 45, wherein the sent information is at least one telemetry measure pertaining to an asset status.

50. A communication system according to claim 49, wherein the asset is a vehicle.

51. A communication system according to claim 50, wherein the asset status is information about one of speed, direction, airbag deployed, engine on, tire pressure, fuel level.

52. A communication system according to claim 49, wherein the asset is a person.

53. A communication system according to claim 52, wherein the asset status is information about one of heartbeat, body temperature, blood pressure, blood sugar level, or respiration rate.

54. A communication system according to claim 39, wherein the asset server pushes information to the mobile device through the hole.

55. A communication system according to claim 54, wherein the pushed information pertains to at least one other asset in the asset tracking system.

56. A communication system according to claim 54, wherein the pushed information pertains to a position to which the asset should proceed.

57. A communication system according to claim 56, wherein the pushed information includes real-time information.

58. A communication system according to claim 56, wherein the real-time information includes information about a status of a location at the position.

59. A communication system according to claim 58, wherein the real-time information includes one of blueprints, occupancy, items stored at the location, a history of the location, a history of occupants at the location.

60. A communication system according to claim 39, wherein the successive communication is a successive heartbeat.

61. A communication system according to claim 39, wherein the heartbeat is specific to the mobile device that originates the heartbeat.

62. A communication system according to claim 61, wherein the heartbeat is a digital signal, wherein the digital signal includes a plurality of bits that identify the mobile device.

63. A communication system according to claim 39, wherein the cellular device sends and receives digital signals.

64. A communication system according to claim 39, wherein the cellular device includes a digital modem to send data to the wireless network.

65. A communication system according to claim 39, wherein the cellular device multiplexes a plurality of data streams into an out-going data stream.

66. A communication system according to claim 65, wherein the plurality of data streams includes one of voice data, asset position data, asset status data, the heartbeat, or mobile device identifier.

67. A communication system according to claim 39, wherein the asset server comprises:
a. a plurality of parsers; and,
b. a message switch coupled in communication to the plurality of parsers.

68. A communication system according to claim 67, wherein the parser receives and sends information to the mobile device.

69. A communication system according to claim 68, wherein a first parser receives and sends information from a cellular device and a second parser receives and sends data to a different communication device.

70. A communication system according to claim 69, wherein the different communication device is one of a radio transmitter, a satellite phone, a remote computer, a private radio network, or a landline phone network.

71. A communication system according to claim 67, wherein the first parser receives information from and sends information to the cellular device information in a first format and the second parser receives information from and sends information to a different communication device in a second format.

72. A communication system according to claim 71, wherein the first parser and the second parser receive information from and send information to the message switch information in a standard format.

73. A communication system according to claim 67, wherein the message switch routes the information.

74. A communication system according to claim 73, further comprising at least one systems coupled in communication to the message switch.

75. A communication system according to claim 74, wherein the coupled system includes one of a customer system, a database, or another mobile device.

76. A communication system according to claim 75, wherein the database stores information from at least one parser.

77. A communication system according to claim 74, wherein the information sent to the coupled system is in a standardized application program interface.

78. An asset tracking device to send data to and receive data from an asset server in an asset tracking system, comprising:
a. an electronic position finder; and
b. a mobile device coupled in communication to the electronic position finder, wherein the mobile device sends at least one heartbeat to the asset server, and the heartbeat creates or maintains a hole in a firewall in a wireless network connecting the mobile device to the asset server.

79. An asset tracking device according to claim 78, wherein the electronic position finder is one of a GPS receiver or a LORAN receiver.

80. An asset tracking device according to claim 79, wherein the GPS receiver sends GPS coordinates to the mobile device to send to the asset server.

81. An asset tracking device according to claim 80, wherein the mobile device sends information to the asset server through the hole.

82. An asset tracking device according to claim 81, wherein the information sent to the asset server includes GPS coordinates.

83. An asset tracking device according to claim 78, wherein the asset server pushes information to the mobile device through the hole.

84. An asset tracking device according to claim 83, wherein the pushed information includes real-time information.

85. An asset tracking device according to claim 84, wherein the real-time information is about one of at least on other asset in the asset tracking system, a location, a direction, or a voice communications

86. An asset tracking device according to claim 85, wherein the information about the location includes one of a blueprint of the location, an address of the location, a number of occupants at the location, an item of information about the occupants of the location, an item stored at the location, a photograph of the location, a map of the location, or a history of the location.

87. An asset tracking device according to claim 78, further comprising an operating system coupled in communication to the mobile device.

88. An asset tracking device according to claim 87, further comprising an array of sensors coupled in communication to the operating system, wherein the array of sensors monitor an asset using the asset tracking device.

89. An asset tracking device according to claim 88, wherein the asset is one of a vehicle, a person, an aerial vehicle, a train car, a water vessel, or a container.

90. An asset tracking device according to claim 89, wherein the array of sensors monitor the vehicle for one of a tire pressure, a fuel level, an airbag deployment, an engine operation, a plow height, a siren operation, or a water pump operation.

91. An asset tracking device according to claim 89, wherein the array of sensors monitor the person for one of a body temperature, a heartbeat, a blood pressure, a blood sugar level, or a respiration rate.

92. An asset tracking device according to claim 88, wherein the array of sensors sends the collected information to the operating system.

93. An asset tracking device according to claim 92, wherein the operating system processes the collected information.

94. An asset tracking device according to claim 93, wherein the operating system relays the information to the mobile device to be sent to the asset server.

95. An asset tracking device according to claim 93, further comprising a display device coupled in communication to the operating system.

96. An asset tracking device according to claim 95, wherein the operating system sends the collected information to a display device.

97. An asset tracking device according to claim 95, wherein the display device shows a plurality of information to be sent by the mobile device or received by the mobile device.

98. An asset tracking device according to claim 97, wherein the display device shows GIS information of an area surrounding a position of the vehicle.

99. An asset tracking device according to claim 98, wherein the GIS information includes a satellite photograph of the area surrounding a position of the vehicle.

100. An asset tracking device according to claim 98, wherein the GIS information includes a route to take to get to the location.

101. An asset tracking device according to claim 78, wherein the heartbeat is periodic.

102. An asset tracking device according to claim 78, wherein the heartbeat is sporadic.

103. An asset tracking device according to claim 78, wherein the heartbeat is triggered by an event.

104. An asset server in an asset tracking system to send data to and receive data from a mobile device, comprising:
a. at least one parser;
b. a message switch, wherein the message switch receives from or sends to the mobile device at least one heartbeat, and wherein the heartbeat creates or maintains a hole in a firewall in a wireless network connecting the asset server to the mobile device.

105. An asset server according to claim 104, wherein the parser receives asset information from the mobile device to input into the asset tracking system.

106. An asset server according to claim 105, wherein the asset information includes one of an asset position, an asset status, an asset direction.

107. An asset server according to claim 106, wherein the asset position includes one of asset direction, asset coordinates, asset address location.

108. An asset server according to claim 106, wherein the asset is a vehicle.

109. An asset server according to claim 108, wherein the asset status includes one of tire pressure, fuel level, airbag deployment, engine operation, plow height, siren operation, water pump operation.

110. An asset server according to claim 108, wherein the asset is a person.

111. An asset server according to claim 108, wherein the asset status includes one of body temperature, heartbeat, blood pressure, blood sugar level.

112. An asset server according to claim 104, wherein the first parser receives from and sends to the cellular device information in a first format and the second parser receives from and sends to the different communication device information in a second format.

113. An asset server according to claim 112, wherein the first parser and the second parser receive from and send to the message switch information in a standard format.

114. An asset server according to claim 104, wherein the parser receives and sends information to the mobile device.

115. An asset server according to claim 104, wherein a first parser receives and sends information from a cellular device and a second parser receives and sends data to a different communication device.

116. An asset server according to claim 115, wherein the different communication device is one of a radio transmitter, a satellite phone, a remote computer, a private radio network, or a landline phone network.

117. An asset server according to claim 104, further comprising a database coupled in communication with the data server.

118. An asset server according to claim 117, wherein the database stores information sent to the data server through the hole.

119. An asset server according to claim 104, wherein the heartbeat is periodic.

120. An asset server according to claim 104, wherein the heartbeat is sporadic.

121. An asset server according to claim 104, wherein the heartbeat is triggered by an event.

122. An asset tracking system to locate and manage a plurality of assets, comprising
a. a cellular device located with each asset, wherein the cellular device transmits a periodic heartbeat, and wherein the cellular device includes
i. a cellular modem; and,
ii. a GPS receiver coupled to the cellular modem, wherein the GPS receiver sends GPS coordinates to the cellular modem for transmission;
b. a wireless, packet-switched network coupled in communication to the cellular device that receives the GPS coordinates, wherein the cellular network includes
i. a wireless interface that receives the transmitted GPS signals from the cellular modem;
ii. a firewall, wherein the firewall opens a hole upon receipt of the heartbeat, and wherein the firewall maintains the hole for successive communications between the cellular modem and an asset server;
iii. a network router, wherein the router relays the heartbeat that passes through the firewall onto an internet network; and
c. an asset server coupled to the internet network, wherein the asset server receives the heartbeats from the cellular device, and wherein the asset server includes:
i. at least one parser;
ii. a message switch coupled to the parser.
